(19) United States
(12) Patent Application Publication
(10) Pub. No.: US 2012/0063160 A1
(43) Pub. Date: Mar. 15, 2012

(54) Effiency and quality by applying light extraction means to the collection portion of a linear luminaire

(75) Inventors: Gregory P. Frankiewicz, Mayfield Heights, OH (US); Roger F. Buelow, Gate Mills, OH (US); Jeremias A. Martins, Twinsburg, OH (US); David Bina, Northfield Center, OH (US); Chris H. Jenson, Twinsburg, OH (US)

(73) Assignee: Energy Focus, Inc., Solon, OH (US)

(21) Appl. No.: 13/216,235

(22) Filed: Aug. 23, 2011

Related U.S. Application Data
(60) Provisional application No. 61/375,929, filed on Aug. 23, 2010.
(60) Provisional application No. 61/375,940, filed on Aug. 23, 2010.

(51) Int. Cl. F21V 99/00

(52) U.S. Cl. 362/555

(57) ABSTRACT

Improved side-light distribution systems are disclosed. In one embodiment, an efficient side-light distribution system includes a LED light source; a light coupler for receiving light from the LED light source at a first end and providing light at a second end to an elongated light pipe, and the elongated light pipe receives light from the LED light source at a first end and transmitting the light towards a second end. The coupler transforms at least the angular distribution of at least 70% of the light from the LED light source into an appropriate angular distribution needed for total internal reflection at a second end within the elongated light pipe. The light coupler includes a light-extraction means between the first and second ends of the light coupler for extracting light out of a side of the light coupler. At least part of the light within the light pipe is extracted out of a side of the light pipe, between the first and second ends of the light pipe, by a light-extraction means.

### CROSS-REFERENCE TO RELATED APPLICATIONS

This application claims priority to U.S. Provisional Patent Application No. 61/375,929 filed on Aug. 23, 2010, and U.S. Provisional Patent Application No. 61/375,940 filed on Aug. 23, 2010, the disclosures of each of which is herein incorporated herein by reference.

### FIELD OF THE INVENTION

The lighting system relates to improved efficiencies and uniformity of light distribution along the length of a light pipe.

### BACKGROUND OF THE INVENTION

As a contemplated precursor for the present invention, which precursor is not believed to be prior art, the present inventors have contemplated a side-light distribution system comprising an LED light source for providing light to a light pipe via a light coupler that conditions light from the LED light source for total internal reflection (TIR) propagation through the light pipe. The light pipe includes light-extraction means for extracting light from the side of the light pipe, transverse to the main path of TIR light propagation through the light pipe. The light coupler is solid and is generally governed by the laws of Etendue, relating to the preservation of brightness of light. The contemplated precursor has a light coupler and a light pipe that are manufactured as discrete parts due to typical manufacturing methods required to obtain the necessary optical clarity in their materials.

One of the shortcomings of the contemplated precursor relates to the system of light coupler and light pipe only emitting light from the side of the system, along its length, only from the light pipe. That portion of the lighting system'occupied by the light coupler does not contribute to side-light emission from the system, which may leave a dark region in the lighting system from the perspective of a viewer or user of the system. This drawback would become aggravated where the light coupler occupies proportionately more of the lighting system of light coupler and light pipe.

It would be desirable to provide a lighting system that reduces that portion of the system not contributing to side-light emission from the system.

### SUMMARY OF THE INVENTION

In one preferred embodiment, an efficient side-light distribution system comprises: a LED light source; a light coupler for receiving light from the LED light source at a first end and providing light at a second end to an elongated light pipe, and the elongated light pipe receives light from the LED light source at a first end and transmitting the light towards a second end.

The coupler transforms the angular distribution of at least 70% of the light from the LED light source into an appropriate angular distribution needed for total internal reflection at a second end within the elongated light pipe. The light coupler includes a light-extraction means between the first and second ends of the light coupler for extracting light out of a side of the light coupler. At least part of the light within the light pipe is extracted out of a side of the light pipe, between the first and second ends of the light pipe, by a light-extraction means.

One advantage of this efficient side-light distribution system is that the distribution of light along its length will be more uniform, without dark areas where the light coupler is located.

Another advantage is that adding a light-extraction means to the light coupler decreases the dark areas around them, extracting more light and improving efficiency.

Yet another advantage is that combining the light-extraction means at the light coupler with intervening lengths of light pipe can create more design space.

In addition to the foregoing advantages, if the light pipe can also perform some angular transformation of the light along its length, then the light coupler may be made smaller since it does not need to fully transform the light.

### BRIEF DESCRIPTION OF THE FIGURES

FIG. 1 is a side plan view of an exemplary side-light distribution system which couples light from a LED light source into a simple light pipe.

FIG. 2 is a side plan view of an exemplary side-light distribution system which couples light from a LED light source via a light coupler having light-extraction means into a simple light pipe.

FIG. 3 is a side plan view of an exemplary integrated side-light distribution system which couples light from a LED light source via a light coupler having light-extraction means into a simple light pipe.

FIG. 4 is a side plan view of an exemplary side-light distribution system which couples light from a LED light source via sequentially arranged first stage and a second stage light couplers into a simple light pipe.

### DETAILED DESCRIPTION OF THE INVENTION

The examples and drawings provided in the detailed description are merely examples, which should not be used to limit the scope of the claims in any claim construction or interpretation.

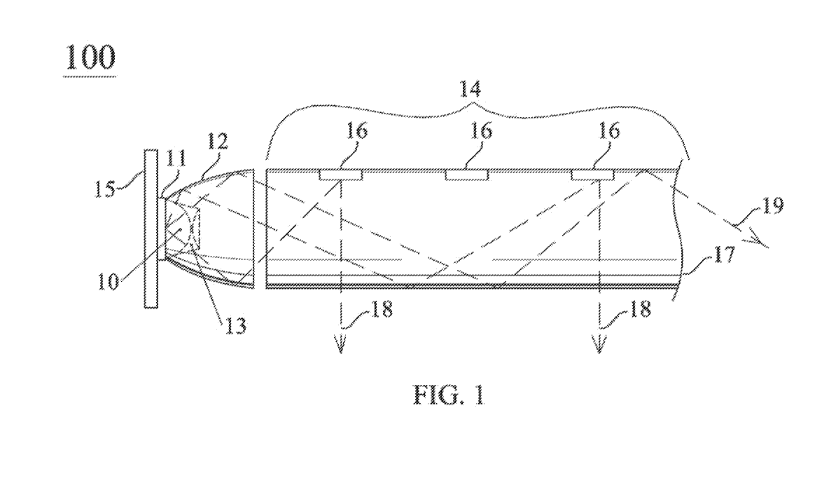

The side-light distribution system of FIG. 1 was a consideration of the present inventors in developing the presently claimed invention, and by itself is not believed to constitute prior art. LED light source 10 is described first, for explaining an advantage of the claimed invention.

In FIG. 1, the side-light distribution system 100 includes: a LED light source 10, a solid light coupler 12, and a light pipe 14. LED Light source may be one or more LEDs. Light source 10 is coupled to a lens 13. Light coupler 12 transforms the light from light source 10 into an optimal angular distribution to the light pipe 14 along its length (i.e., in an axial direction). Light rays 19 are reflected out via total internal refection (TIR). Light source 10 is coupled to a heat sink 11 and mounted on a printed-circuit board 15, as shown in FIGS. 1-4.

In one embodiment of the heat sink, the heat sink can be composed of a metal such as aluminum or zinc. Light sources such as LEDs tend to generate significant localized heat, which, if not quickly removed from the LEDs, will significantly shorten their lifetime.

The gap between the light coupler and the light pipe is usually small but has been slightly exaggerated for purposes of clarity, in FIGS. 1, 2 and 4, to show the different components of the side-light distribution system.

Light-extraction means 16 are applied to the light pipe 14 in order to extract and distribute the light from the light pipe in a direction 18 that is generally perpendicular to the longitudinal axis of the light pipe. Other angle variations may also be utilized. As shown in the figure, the second end 17 of the light pipe 14 is represented by a wavy line, showing that the second end may terminate at such a point or be coupled to a mirror, for example, and at the end of the mirror, the second end can be positioned there.

Light Coupler Having a Light-Extraction Means and a Light Pipe

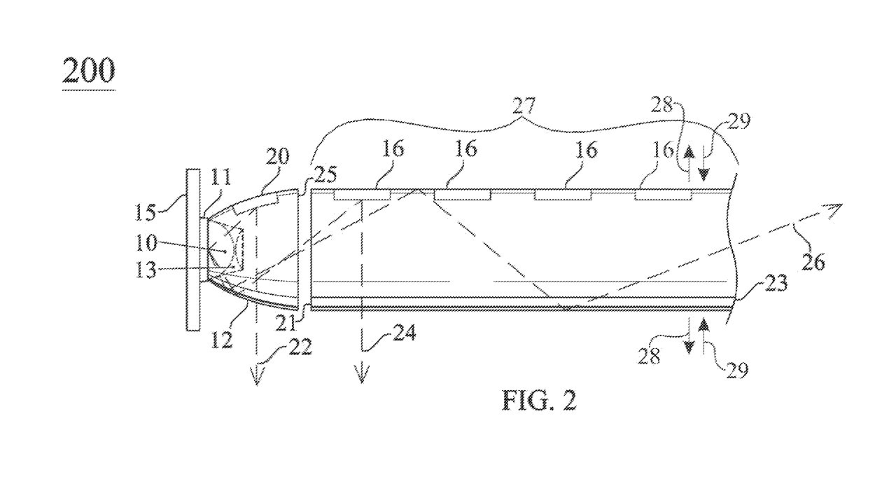

In FIG. 2, an efficient side-light distribution system 200 includes: a LED light source 10 with light-extraction means 20 added to the light coupler 12 having an output end 25. Lens 13 is added to a LED light source, which may be one or more LEDs, where LED represents a light-emitting diode. By adding a means to extract light from the light coupler 12, the extraction of light 22 to the side may occur closer to the light source 10.

The light coupler 12 is designed to reduce the angular distribution of light generated from the light source 10, resulting in a collection of light rays, including light ray 26 that propagates along the length of the light pipe 27.

Furthermore, as shown in FIG. 2, the efficient side-light distribution system 200 includes light-extraction means 16 which are added to a light pipe 27 and are separate from the light-extraction means 20 in the light coupler.

The light pipe 27 includes an inlet end 21 and a second end 23. As shown in the figure, the second end 23 is represented by a wavy line, showing that the second end may terminate at such a point or be coupled to a mirror, for example, or other apparatus known to a person of ordinary skill. In such a case, at the end of the mirror, the second end 23 can be positioned there.

Light rays such as light ray 24 that impinge on the light-extraction means 16 may be scattered or reflected from the light-extraction means 16 at an angle that allows the light ray 24 to exit the light pipe.

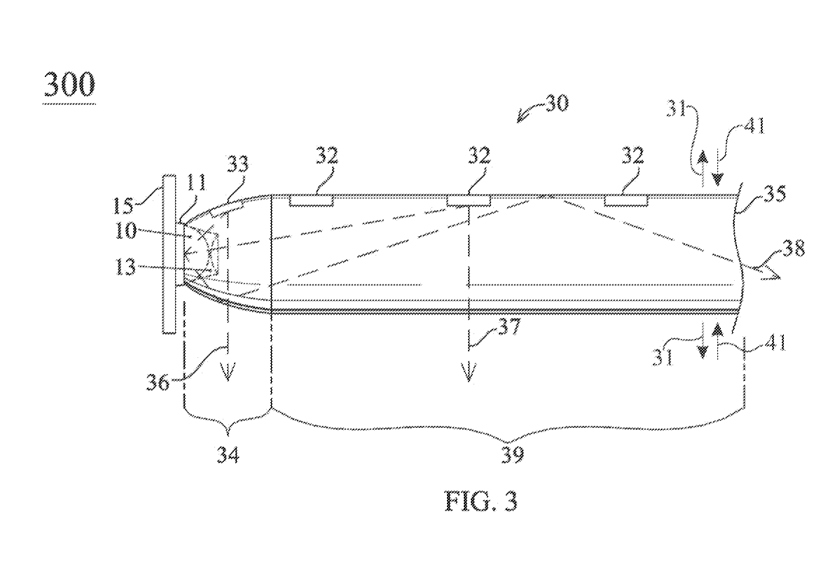

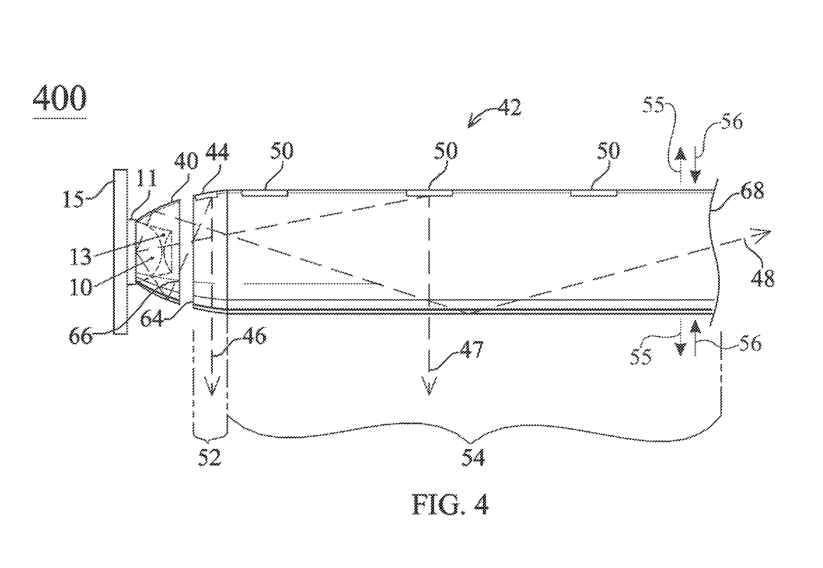

The light coupler or light pipe, or both components in FIG. 2 may have a cross-sectional area increased or decreased, as indicated by an up and down arrows shown. Arrows 28 indicate an increase in cross-sectional area. Arrows 29 indicate a decrease in cross-sectional area. Such change in cross-sectional area can also occur in the embodiments of FIGS. 3-4, which include the respective arrows.

Alternatively, like the embodiment of FIG. 3, discussed later, light coupler 12 may be physically joined to light pipe 27 such as with index-matching optical adhesive, or by being integrally and gaplessly joined together with homogeneous material, such as would result from being formed together in the same mold.

In one example of the side-light distribution system, the light pipe includes a number of light couplers. In another example, the light couplers may occupy ranges from less than about 10%, more than 10% but less than about 50% or more than 50% but less than about 90% of the length of the total side-light distribution system. The term “about” takes into account experimental variations that will be understood by a person of ordinary skill in the art.

Integral Light Pipe Having a Coupler Section and a Light-Extraction Section

In FIG. 3, the side-light distribution system 300 includes: a LED light source 10, and a light pipe 30. Lens 13 is added to a light source, may be one or more LEDs.

The side-light distribution system 30 includes a coupler section 34 and a light pipe section 39. The coupler section 34 includes a light-extraction means 33, while the light pipe section 39 includes a plurality of light-extraction means 32, for example.

A light-extraction means 33 is positioned such that light pipe 30 extracts light ray 36 closer to the light source. Any number of light-extraction means 32 may be added, depending on how much light rays 36 and 37 needs to be extracted from the angular distribution of light ray 38 along the length of the light pipe, (i.e., in one example, in the axial direction) at specified distances from light source 10.

Coupler section 34 of the side-light distribution system 30 may be made shorter or longer, or eliminated completely, depending on how much light needs to be extracted close to light source 10. A longer coupling section causes light to propagate further into light pipe 39. A shorter coupling section 34 causes light to exit the side light-extraction section 39, closer to the light source 10.

The light pipe 39 includes a second end 35. As shown in the figure, the second end 35 is represented by a wavy line, showing that the second end may terminate at such a point or be coupled to a mirror, or other apparatus known to a person of ordinary skill.

In this example, the mold of FIG. 3 may be created from a solid material such as metal or plastic. The desired shape can be machined into the block of material. A polymerizable material is added to the mold and cured. Once cured, the molded part is removed from the mold. This process may be used to create an integrated coupler and light pipe in other embodiments.

The light pipe 30 in FIG. 3 may have a cross-sectional area increased or decreased, as indicated by an up and down arrows shown. Arrows 31 indicate an increase in cross-sectional area. Arrows 41 indicate a decrease in cross-sectional area.

One of the primary advantages of the single molded piece that includes the coupler section and the light pipe section is the conservation of light within the system. As light is transmitted between materials of different refractive indices, light is reflected at the interface. In the case of light transmitting between two separate pieces, a light coupler 12 and a light pipe 14 such as shown in FIG. 1, 8% of the light is lost due to reflections. The first loss of 4% occurs as the light exits the light coupler 12 into the air. A second loss of 4% occurs as the light moves from the air into the light pipe 14. 4% of light is reflected off an input end of the light pipe 14, towards an output side of the light coupler 12. If the light coupler 12 and the light pipe 14 are made as a single piece, such as shown in FIG. 3, then the interface between the two components is eliminated, preserving 8% of light and increasing the light available for illumination. Other ways of creating the single unit are disclosed in U.S. Provisional Patent Application No. 61/375,929 for Method for Fabricating a Single Optical element to Increase the Efficiency of the Linear Luminaire Illumination System, on Aug. 23, 2010, and U.S. Application Ser. No. 61/375,940 entitled, “A Method for Making a Combined Light Coupler and Light Pipe,” filed on Aug. 23, 2010, the disclosures of which is incorporated herein by reference.

Light Coupler and a Light Pipe Having a Coupler Section and a Light-Pipe Section

In FIG. 4, a side-light distribution system 400 includes: a LED light source 10, a smaller light coupler 40 without a light-extraction means (unlike the embodiment of FIG. 2) and a light pipe 42 having a coupler section 52 and a light pipe section 54. Lens 13 is added to a LED light source, which may be one or more LEDs.

The coupler section 52 includes a light-extraction means 44. In addition, the light pipe section 54 includes a set of light-extraction means 50. In another example, there may be only one light-extraction means 50.

A light-extraction means 44 is positioned such that light pipe 42 extracts light rays 46 and 47 closer to light source 10 and the remainder of the light, i.e., light ray 48 from light coupler 40 is transformed into an angular distribution along the length of the light pipe 42. (i.e., in one example, in the axial direction).

The light pipe 42 includes an inlet end 64 and a second end 68. As shown in the figure, the second end 68 is represented by a wavy line, indicating that the second end may terminate at such a point or be coupled to a mirror, for example, or other apparatus known to a person of ordinary skill. At the end of the mirror, the second end can be positioned there.

Alternatively, like the embodiment of FIG. 3, the embodiment of FIG. 4 may be formed as one unit, with the light coupler and the light pipe fused as one unit. The light coupler 40 may be physically joined to light pipe 42 such as with index-matching optical adhesive, or by being integrally and gaplessly joined together with homogeneous material, such as would result from being formed together in the same mold, for example.

The examples described in the specification and claims also apply to other embodiments of a light pipe. The light pipe would be designed the same way as the side-light distribution system 400 shown in FIG. 4, with a light source at the light coupling end and a light pipe at the opposite end. Therefore, it could be made in an end-light mode or in a side-light mode, where light is extracted from the sides of the light pipe to provide illumination along its length.

In another example, the added light coupler to the light pipe may be a solid, integral with the light pipe, and may include light-extraction means.

In one example, the light coupler is a separate portion placed at a distance such that the light coupler is in “optical contact” with the light pipe. “Optical contact,” occurs when two surfaces are in optical contact, light traveling from one surface to the next surface will not experience a reflection as it leaves one surface and enters the next surface. Either the medium through which the light passes is the same or has substantially the same refractive index.

Further discussion of light pipes are disclosed in U.S. Pat. No. 7,163,326, the contents of which are incorporated herein by reference.

The light pipe 42 in FIG. 4 may have a cross-sectional area increased or decreased, as indicated by an up and down arrows shown. Arrows 55 indicate an increase in cross-sectional area. Arrows 56 indicate a decrease in cross-sectional area.

### Non-Imaging Light Coupler

A “non-imaging” coupler, as used herein, tolerates minor manufacturing imperfections while retaining substantially the full functionality of an ideally formed non-imaging coupler.

Normally, the light coupler only transforms light from the light source into the proper angular distribution required by the light pipe. The light pipe normally only transports light down its length (via total internal reflection), delivering the light to the end opposite the light source. Also, the light-extraction means only extracts light transverse to the length of the light pipe; it does not collect light from a light source or perform any angular transformation of the light.

Regarding the light coupler, its interiorly-directed reflective surface is normally the primary device for receiving light from a light source. It then transmits that light toward a light-receiving portion of a light pipe, which is discussed in later paragraphs. This reflective surface is typically specular if the light coupler is hollow, or of the TIR-type if the light coupler is solid, where TIR means total internal reflection.

The rules of non-imagine optics govern the configuration of the light coupler at least approximately. As known in the art, the rules of non-imaging optics are concerned with the optimal transfer of light radiation between a source and a target. In contrast to traditional imaging optics, non-imaging techniques do not attempt to form an image of the source; instead, an optimized optical system for radiative transfer from a source to a target is desired.

The two design problems that non-imaging optics solves better than imaging optics are as follows. First, (1) concentration—maximizing the amount of energy applied to the target (as in solar power, for instance, “collecting radiation emitted by high-energy particle collisions using the fewest number of photomultiplier tubes”). Second, (2) illumination—controlling the distribution of light, typically so it is “evenly” spread over some areas and completely blocked from other areas (as in automotive headlamps, LCD backlights, etc.).

Typical variables to be optimized at the target include the total radiant flux, the angular distribution of optical radiation, and the spatial distribution of optical radiation. These variables on the target side of the optical system often must be optimized while simultaneously considering the collection efficiency of the optical system at the source.

Typically, a light coupler at least approximately governed by the rules of non-imaging optics has a profile that changes from the inlet end toward the outlet end to condition the angular distribution of light provided to a rod-shaped light pipe. That is, as light propagates through the light coupler, its angular distribution changes. In addition, the interior surface of a solid light coupler may be configured to aid in the conditioning of light provided to a rod-shaped light pipe.

This change in the angular distribution of light conditions the light for distribution by the light pipe. Three examples are as follows. First, (1) the light may be conditioned to reduce the angular distribution of light to be significantly below the numerical aperture or acceptance angle of a light pipe so that it propagates along the entire length of the light pipe and is distributed out the opposite end.

In a second example (2), the angular distribution of light leaving the light coupler can be higher but closer, or even beyond, the numerical aperture (NA) of the light pipe. In this case, the light leaving the light coupler with a higher angular distribution will see a greater number of interactions with the sides of the light pipe, thereby increasing the opportunity for distribution out the side of the light pipe over a shorter distance.

In a third example (3), the profile of the light coupler changes so that the light leaving the light coupler is not only conditioned to cause the angular distribution to be within an intended NA, but also is conditioned to cause the light to be uniformly distributed among a greater number of angles. In this case, at least approximately governed by the rules of non-imaging optics, the profile of the light coupler will typically grow in size and then decrease as it approaches and reaches the light pipe. Because the resulting light is conditioned so that light is present at a multitude of angles, light with higher angles will have more interactions with the side of the light pipe and will be distributed over shorter distances, and light with lower angles will see fewer interactions so will be distributed over longer distances. The result may be a more uniform distribution out of the light pipe along its entirety.

With respect to the light coupler, the couplers can have an increasing cross-sectional area from a light coupling inlet end and a light coupling outlet end. The change in area for the light coupler can be of a non-monotonic function, for example, a compound parabolic curve. The increase in cross-sectional area of the light coupler may follow the pattern disclosed in U.S. Pat. No. 6,219,480, the disclosure of which is incorporated herein by reference. More specifically, the cross-sectional area of the light coupler increases in a continuous manner, where “continuous” means that the cross section at a point along an axial length transitions to a next point without any substantial discontinuities.

Alternatively, the cross-sectional area of the light coupler can increase and decrease in a continuous manner, where “continuous” means that the cross section at a point along an axial length transitions to a next point without any substantial discontinuities.

In another example, the cross-sectional area of the light coupler increases or decreases in a continuous manner, where “continuous” means that the cross section at a point along an axial length transitions to a next point without any substantial discontinuities. For example, a central path of light propagation occurs from an inlet end to an outlet end, where a cross-section increases from a first cross-sectional area to a maximum cross-sectional area and then decreases in cross-section to a final cross-sectional area larger than the first cross-sectional area.

### Light Pipe

A “light pipe” as used herein preferably comprises an elongated rod. By “elongated” it is meant being long in relation to width or diameter, for instance, where the “long” dimension can be both along a straight path or a curved path.

One end of the light pipe receives light from an associated light coupler. The elongated rod has an elongated sidewall and light-extraction means along at least part of the elongated sidewall for extracting light through the sidewall and distributing said light to a target area. At least, the part of the light pipe having light-extraction means is preferably solid, although there may exist in the arrangement small voids caused by manufacturing processes, for instance, voids that have insubstantial impact on the side-light light-extraction and distribution properties of the light pipe.

A light pipe as used herein has a cross section along a main axis of light propagation through the pipe that is more round than flat. For example, the minimum cross-sectional dimension is preferably more than 50% of the maximum cross-sectional dimension. In a preferred embodiment, the cross-section of the light pipe is substantially circular.

Preferably, a light pipe is rigid, by which is meant that at 20 degrees Celsius the arrangement has a self-supporting shape such that the light pipe returns to its original or approximately original (e.g., linear or curved) shape after being bent along a main path of light propagation through the light pipe. However, if the light pipe is flexible, it is meant that the light pipe has a shape that will be bent to a shape that has a curvature when being bent along its longitudinal axis.

The preferred embodiment of the light pipe is one that includes a constant cross-sectional area, within manufacturing tolerances known to a person of ordinary skill. Such constant cross-sectional area is within a + or −5% deviation. In one example, a useful embodiment of the system may include a monotonically increasing cross-sectional area of the light pipe. The increasing cross-sectional area reduces the angular distribution of light passing through the light coupler, so as to enable the light rays to propagate at higher angles while maintaining total internal reflection.

The decreasing cross-sectional area aids in extraction of light from the sides of the light pipe, because the angles of light effectively become steeper with respect to the covering surface of the light pipe.

The light pipe may have a nearly constant cross-sectional area: The term “nearly constant” cross-sectional area indicates a generally constant cross-sectional area with + or −5% deviation. The cross-sectional area of the light pipe may become “gradually larger” starting from the inlet end and moving towards the second end of the light pipe. Alternatively, the cross-sectional area of the light pipe may become “gradually smaller” starting from the inlet end and moving towards the second end of the light pipe. When defining “gradually larger” or “gradually smaller,” the cross-sectional area increases or decreases in a continuous manner, where “continuous” means that the cross section at a point along an axial length transitions to a next point without any substantial discontinuities, as disclosed in the foregoing '480 patent. The change in cross-sectional area is of a monotonic function.

### Light-Extraction Means

Now specific examples of the light-extraction means will be discussed. Light-extraction means may be of various types whose selection will be routine to those of ordinary skill in the art. For instance, three types of light-scattering means are disclosed in U.S. Pat. No. 7,163,326, entitled “Efficient Side-light Luminaire with Directional Side-Light-Extraction,” assigned to Energy Focus, Inc. of Solon, Ohio. In brief, these three types are (1) discontinuities on the surface of a light pipe, (2) a layer of paint on the surface of a light pipe, and (3) a vinyl sticker applied to the surface of a light pipe.

In more detail, (1) discontinuities on the surface of a light pipe may be formed, for instance, by creating a textured pattern on the light pipe surface by molding, by roughening the light pipe surface with chemical etchant, or by making one or more notches in the side of a light pipe.

In another example, the light-extraction means may comprise a layer of paint exhibiting Lambertian-scattering and having a binder with a refractive index about the same as, or greater than that of, the core. Suitable light-extraction particles are added to the paint, such as titanium dioxide or many other materials as will be apparent to those of ordinary skill in the art. Preferably, the paint is an organic solvent-based paint.

In yet another example, the light-extraction means may comprise vinyl sticker material in a desired shape applied to the surface of the light pipe. Appropriate vinyl stickers have been supplied by Avery Graphics, a division of Avery Dennison of Pasadena, Calif. The film is an adhesive white vinyl film of 0.146 mm, typically used for backlit signs.

In another example, the light-extraction means may be continuous, intermittent, or both, along the length of a light pipe, for instance. An intermittent pattern is shown in the above-mentioned U.S. Pat. No. 7,163,326 in FIG. 15A, for instance. To assure that the light-extraction means appears as continuous from the point of view of the observer in a target area to be illuminated, the target area should be spaced from the light pipe in the following manner: the spacing should be at least five times the length of the largest gaps between adjacent portions of paint or other light-extraction means along the main path of TIR light propagation through the light pipe.

Additionally, the foregoing light-extraction patterns may be of the specular type, scattering type, or a combination of both. Generally, a scattering extractor pattern for light on an elongated light pipe tends to provide light onto a target area, along the length of the light pipe, with a moderate degree of directional control over the light in the length direction. In the direction orthogonal to the length, the scattering extractor pattern density and the cross sectional shape of the elongated light pipe provide a smooth target distribution that is free of localized spatial structure but still provides good directional control. Scattering extractor patterns are relatively insensitive to fabrication errors.

In contrast, as used herein, a specular extraction pattern can provide light along the length of a light pipe with more localized control than can a scattering extraction pattern.

In one example, the extraction means may also be a scattering or a specular paint or tape, in either a solid or generally chirped pattern with varying density. In another example, the extraction means may be a cut or a notch in the coupling optic.

The light-extraction means on a light coupler may be of constant width or have varying width along the length of the light coupler. In yet another example, the light-extraction means may have constant width but vary in density, where the light-extraction means may be more dense closer to the light source.

In another example, light-extraction means may have constant width but vary in density, where the light-extraction means may be more dense farther away from the light source. In another example, the light-extraction means on the light coupler may be not regularly spaced.

In another example, the light-extraction means on the light coupler may have differing width. In another example, the light-extraction means on the light coupler includes at least one notch.

In another example, the light-extraction means on the light coupler includes a roughened surface. In yet another example, the light-extraction means on the light coupler includes regularly spaced structural elements.

The foregoing features of the light-extraction means on the light coupler may be also be on at least one light-extraction means on a light pipe.

The following is a list of reference numerals and associated parts as used in this specification and drawings:

### REFERENCE NUMERAL PART

10 LED light source
11 Heat sink
12 Light coupler
13 Lens
14 Light pipe
15 Printed-circuit board
16 Light-extraction means
17 Second end
18 Light ray
19 Light ray
20 Light-extraction means
21 Inlet end
22 Light ray
23 Second end
24 Light ray
25 Output end
26 Light ray
27 Light pipe
30 Light pipe
32 Light-extraction means
33 Light-extraction means
34 Coupler section
35 Second end
36 Light ray
37 Light ray
38 Light ray
39 Light pipe section
40 Light coupler
42 Light pipe
44 Light-extraction means
46 Light ray
47 Light ray
48 Light ray
50 Light-extraction means
52 Coupler section
54 Light pipe section
64 Inlet end
68 Second end
100 Side-light distribution system
200 Side-light distribution system
300 Side-light distribution system
400 Side-light distribution system

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. An efficient side-light distribution system comprising:
a) a LED light source;
b) a light coupler for receiving light from the LED light source at a first end and providing light at a second end to an elongated light pipe; wherein the coupler transforms at least the angular distribution of at least 70% of the light from the LED light source into an appropriate angular distribution needed for total internal reflection at a second end within the elongated light pipe;
c) the elongated light pipe receiving light from the LED light source at a first end and transmitting said light towards a second end; wherein at least part of the light within the light pipe is extracted out of a side of the light pipe, between the first and second ends of the light pipe, by a light-extraction means; and
d) the light coupler including a light-extraction means between the first and second ends of the light coupler for extracting light out of a side of the light coupler.

2. The efficient side-light distribution system of claim 1, wherein the light coupler is and the light pipe are formed of discrete parts.

3. The efficient side-light distribution system of claim 1, wherein the light coupler is integrally and gaplessly joined with the light pipe.

4. The efficient side-light distribution system of claim 1, wherein:
a) the light coupler comprises sequentially arranged first and second stages;
b) the first stage directly receives light from the LED light source and is free of light-extraction means for extracting light from a side of the coupler between the first and second ends of the coupler;
c) the second stage transmitting light received from the first stage to the light pipe, wherein the second stage includes said light-extraction means for the light coupler.

5. The efficient side-light distribution system of claim 1, where the light coupler has an increasing cross-sectional area from the first end of the light coupler to the second end of the light coupler, reducing the angular distribution of light passing through the light coupler from the first end of the light coupler to the second end of the light coupler.

6. The efficient side-light distribution system of claim 1, where the light pipe has a nearly constant cross-sectional area along a path from the first end of the light pipe to the second end of the light pipe.

7. The efficient side-light distribution system of claim 6, where the light pipe cross-sectional area along a path from the first end of the light pipe to the second end of the light pipe becomes gradually larger.

8. The efficient side-light distribution system of claim 6, where the light pipe cross-sectional area along a path from the first end of the light pipe to the second end of the light pipe becomes gradually smaller.

9. The efficient side-light distribution system of claim 1, wherein the light coupler occupies less than 10% of the combined length of the light coupler and light pipe.

10. The efficient side-light distribution system of claim 1, wherein the light coupler occupies more than 10% but less than 50% of the combined length of the light coupler and light pipe.

11. The efficient side-light distribution system of claim 1, wherein the light coupler occupies more than 50% but less than 90% of the combined length of the light coupler and light pipe.

12. The efficient side-light distribution system of claim 1, wherein the light coupler and the light pipe are glued together using an index-matching adhesive.

13. The efficient side-light distribution system of claim 1, wherein the light coupler is solid.

14. The efficient side-light distribution system of claim 1, wherein the light coupler is hollow.
